(19) United States
(12) Patent Application Publication
(10) Pub. No.: US 2017/0036246 A1
(43) Pub. Date: Feb. 9, 2017

(54) CLEANING SYSTEM FOR PHOTOVOLTAIC POWER STATION

(71) Applicants: BOE TECHNOLOGY GROUP CO., LTD., Beijing (CN); BEIJING BOE ENERGY TECHNOLOGY CO., LTD., Beijing (CN)

(72) Inventors: Zaifu SUN, Beijing (CN); Xianwei HOU, Beijing (CN); Xiandong ZHANG, Beijing (CN); Xingbin SONG, Beijing (CN); Jinwei LIU, Beijing (CN)

(73) Assignees: BOE TECHNOLOGY GROUP CO., LTD., Beijing (CN); BEIJING BOE ENERGY TECHNOLOGY CO., LTD., Beijing (CN)

(21) Appl. No.: 14/909,715

(22) PCT Filed: Aug. 31, 2015
(86) PCT No.: PCT/CN2015/088555

§ 371 Date: Feb. 2, 2016

(30) Foreign Application Priority Data
Mar. 26, 2015 (CN) 201510137873.1

(51) Int. Cl. B08B 3/02; H02S 50/00; H02S 40/10; B08B 3/14; B08B 13/00

(52) U.S. Cl. CPC B08B 3/02; B08B 3/14; B08B 13/00; H02S 40/10; H02S 50/00

(57) ABSTRACT

The present disclosure relates to a cleaning system for a photovoltaic power station, including a sprinkler, a dust detector configured to detect a dust content at a surface of a solar assembly and send a signal when the dust content at the surface of the solar assembly meets a first predetermined condition, and a controller configured to control the sprinkler to clean the solar assembly in accordance with the signal from the dust detector.

### CROSS-REFERENCE TO RELATED APPLICATION

The present application claims a priority of the Chinese patent application No. 201510137873.1 filed on Mar. 26, 2015, which is incorporated herein by reference in its entirety.

### TECHNICAL FIELD

The present disclosure relates to the field of solar energy technology, in particular to a cleaning system for a photovoltaic power station.

### BACKGROUND

As the green power, photovoltaic power stations have attracted more and more attentions nowadays, and the number and size of the photovoltaic power stations on roofs have been increased constantly. Irradiation intensity received by a solar assembly will be adversely affected by the dust on a surface thereof, resulting in a serious influence on a power generation efficiency of the power station. To be specific, when the assembly is partially shielded by such obstructions as dust, a hot spot effect will occur, the power generation efficiency will be reduced, and even the assembly will be burnt out. When the solar assembly is at a too high temperature, its power generation efficiency will be reduced too. In this regard, it is very important to clean and cool the photovoltaic power station. For photovoltaic power stations on roofs, they are mainly cleaned manually due to their installation positions and the limited load borne by the roofs, resulting in a low cleaning efficiency and a high cost.

### SUMMARY

In order to solve the above technical problem, the present disclosure provides a cleaning system for a photovoltaic power station, which can automatically and effectively clean and cool the photovoltaic power station.

In order to achieve the above object, the present disclosure adopts following technical solutions. A cleaning system for a photovoltaic power station includes: a sprinkler; a dust detector configured to determine a dust content at a surface of a solar assembly, and send a signal when the dust content at the surface of the solar assembly meets a first predetermined condition; and a controller configured to control the sprinkler to clean the solar assembly in accordance with the signal from the dust detector.

Further, the dust detector includes: a transparent detection plate arranged at a periphery of the solar assembly; and a fiber optical sensor configured to emit a light beam perpendicular to the transparent detection plate and configured to sense light intensity of a received light beam reflected by dust on the transparent detection plate, determine the dust content at the surface of the solar assembly in accordance with the light intensity, and send a signal when the light intensity exceeds a first predetermined value. When the light intensity exceeds the first predetermined value, the dust content at the surface of the solar assembly meets the first predetermined condition.

Further, the dust detector includes a light source configured to emit a light beam perpendicular to the transparent detection plate.

Further, the sprinkler includes: a water tank; a pump connected to the water tank; a sprayer connected to the pump via a pipe; and a solenoid valve arranged on the pipe and connected to the controller so as to control the flow of the sprayer.

Further, the cleaning system includes a liquid level detector configured to detect a water level of the water tank, and send a signal when the water level is less than a second predetermined value. The controller is further configured to control the sprinkler to stop cleaning the solar assembly in accordance with the signal from the liquid level detector.

Further, the sprinkler includes an adjustment mechanism configured to control an angle of the sprayer relative to a horizontal plane, thereby adjusting a spraying radius of the sprayer.

Further, the cleaning system includes a frequency converter configured to adjust the flow of the pump and soft-start the pump.

Further, the cleaning system includes a heater arranged on the pipe and configured to heat the pipe when a temperature of the pipe is less than a third predetermined value.

Further, the heater is an electric tracing band.

Further, the pipe includes a thermal insulation layer and a fireproofing layer sequentially enclosing the electric tracing band.

Further, the cleaning system includes an ambient detector configured to detect an ambient parameter at a place where the photovoltaic power station is located and send a signal when the ambient parameter meets a second predetermined condition. The controller is further configured to control the sprinkler to clean the solar assembly or stop cleaning the solar assembly in accordance with the signal from the ambient detector.

Further, the sprinkler includes an automatic drain valve arranged on the pipe.

Further, the sprinkler includes a fastener for securing the pipe, and a cushion arranged between the fastener and the pipe.

Further, the cleaning system includes a water recycling device configured to recycle the water for cleaning the solar assembly.

Further, the cleaning system includes a temperature detector arranged at a back surface of the solar assembly, and configured to detect a temperature of the solar assembly, and send a signal when the temperature of the solar assembly exceeds a fourth predetermined value. The controller is further configured to control the sprinkler to clean and cool the solar assembly in accordance with the signal from the temperature detector.

The present disclosure has following benefits. The dust content at the surface of the solar assembly can be effectively determined, thereby effectively cleaning the solar assembly and improving the power generation efficiency.

### BRIEF DESCRIPTION OF THE DRAWINGS

FIG. 1 is a schematic view showing a cleaning system for a photovoltaic power station according to one embodiment of the present disclosure;

FIG. 2 is a schematic view showing a pipe according to one embodiment of the present disclosure;

FIG. 3 is a schematic view showing a water recycling device according to one embodiment of the present disclosure; and

FIG. 4 is a schematic view showing detailed structures of the cleaning system for the photovoltaic power station according to one embodiment of the present disclosure.

### DETAILED DESCRIPTION

The present disclosure will be described hereinafter in conjunction with the drawings and embodiments. The following embodiments are for illustrative purposes only, but shall not used to limit the scope of the present disclosure.

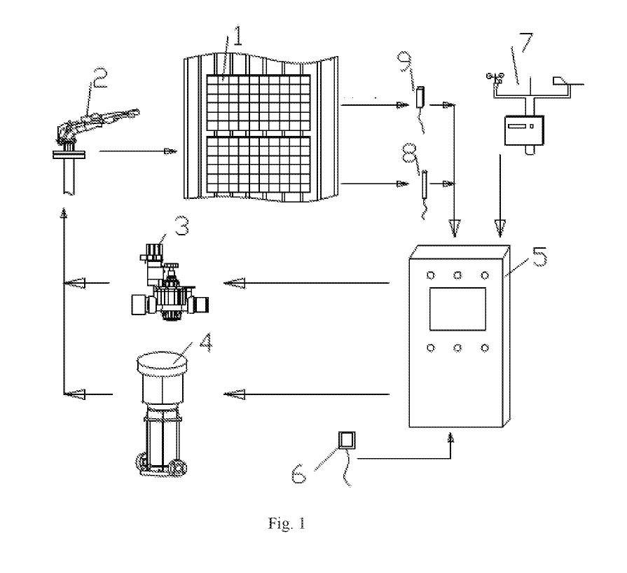

Referring to FIG. 1, the present disclosure provides in some embodiments a cleaning system for a photovoltaic power station, which includes: a sprinkler for cleaning a solar assembly 1 of the photovoltaic power station; a dust detector configured to determine a dust content at a surface of the solar assembly 1, and send a signal when the dust content at the surface of the solar assembly 1 meets a first predetermined condition; and a controller 5 configured to control the sprinkler to clean the solar assembly 1 in accordance with the signal from the dust detector.

The dust detector is provided to determine the dust content at the surface of the solar assembly 1, so as to clean the solar assembly 1 effectively, thereby improving the power generation efficiency.

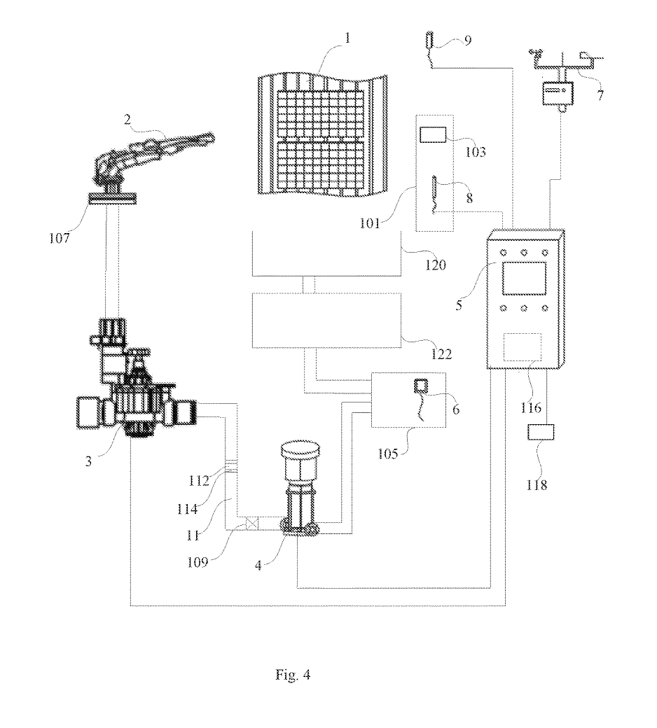

The dust detector may be of various structures, as long as the dust content at the surface of the solar assembly 1 may be determined effectively. In one embodiment, as shown in FIG. 4, the dust detector includes: a transparent detection plate 101 arranged at a periphery of the solar assembly 1; and a fiber optical sensor 8 configured to emit a light beam perpendicular to the transparent detection plate 101, and configured to sense light intensity of a received light beam reflected by dust on the transparent detection plate 101, determine the dust content at the surface of the solar assembly 1 in accordance with the light intensity, and send a signal when the light intensity exceeds a first predetermined value. When the light intensity exceeds the first predetermined value, the dust content at the surface of the solar assembly 1 meets the first predetermined condition.

When there is no dust at the surface of the transparent detector plate 101, the light beam from the optical fiber sensor 8 may directly pass through the transparent detector plate 101. When there is some dust at the surface of the transparent detector plate 101, the light beam from the optical fiber sensor 8 may be diffused at the surface of the transparent detector plate 101, and the reflected light beam is received by the optical fiber sensor 8. The more the dust at the surface of the transparent detection plate 101, the larger the light intensity of the light beam reflected at the surface of the transparent detector plate 101. The optical fiber sensor 8 may determine the dust content at the surface of the solar assembly 1 in accordance with the light intensity, and send a signal when the light intensity exceeds the first predetermined value. When the light intensity exceeds the first predetermined value, the dust content at the surface of the solar assembly 1 meets the first predetermined condition. The first predetermined condition may be set in accordance with practical needs.

Further, the dust detector includes a light source 103. The light source 103 is capable of emitting a light beam perpendicular to the transparent detection plate 101. When the light intensity of the light beam from the optical fiber sensor 8 is insufficient because of weather conditions, the light beam reflected by the transparent detector plate 101 may be relatively weak even when there is dust on the transparent detector plate 101, and at this point, a faulty judgment may occur readily. With the light source 103, it is able to compensate for the light beam from the optical fiber sensor 8, thereby preventing the occurrence of the faulty judgment due to the insufficient light intensity.

Optionally, the sprinkler includes: a water tank 105; a pump 4 connected to the water tank 105; a sprayer 2 connected to the pump 4 via a pipe 11; and a solenoid valve 3 arranged on the pipe 11 and connected to the controller 5 so as to control the flow of the sprayer 2.

In this embodiment, through the above structure of the sprinkler, a certain pressure may be applied to the water from the sprayer 2, and the flow of the sprayer 2 may be controlled by the solenoid valve 3 on the pipe 11. As a result, it is able to clean the solar assembly 1 in a more effective manner.

The sprinkler further includes an adjustment mechanism 107 configured to control an angle of the sprayer 2 relative to a horizontal plane, thereby adjusting a spraying radius of the sprayer 2.

A rotatable water curtain having a radius of tens of meters may be formed by the sprayer 2, so as to cover the photovoltaic power station uniformly, thereby achieving an ideal cleaning and cooling effect. The sprayer 2 may be rotatable automatically, and its rotation angle range may be adjustable, i.e., the angle of the sprayer 2 relative to the horizontal plane may be adjusted by the adjustment mechanism 107 so as to adjust the spraying radius of the sprayer 2. When the water from the sprayer 2 falls uniformly onto the solar assembly 1 at a certain impact force, it is able to improve the cleaning effect.

The sprayer 2 may be firmly secured onto a roof through cobblestones, so as to reduce the vibration at a joint of the sprayer 2.

The sprinkler further includes an automatic drain valve 109 arranged on the pipe 11, so as to prevent devices from being damaged when the water in the pipe 11 is frozen in winter.

The sprinkler further includes a fastener 112 for securing the pipe 11, and a cushion 114 is arranged between the fastener 112 and the pipe 11 so as to prevent the pipe 11 from being damaged due to the expansion and contraction of the pipe 11.

In this embodiment, the cleaning system is arranged on the roof, and when the atmospheric temperature is changed, the pipe 11 on the roof, especially a color steel roof, may be deformed significantly (both the roof and the pipe 11 may be deformed). Hence, a hose may be used to connect the pipe 11 so as to accommodate the deformation.

Optionally, the cleaning system further includes a frequency converter 116 configured to adjust the flow of the pump 4 and soft-start the pump 4.

The flow of the pump 4 may be adjusted so as to reduce the power consumption, and the pump 4 may be soft-started so as to reduce the power consumption and protect the pump. In this embodiment, the converter 116 may be integrated into the controller 5.

Optionally, a heater is arranged on the pipe 11 so as to heat the pipe 11 when a temperature of the pipe 11 is less than a third predetermined value. In this way, the cleaning system may also be used in winter. The third predetermined value may be set in accordance with the practical needs.

Further, the heater is an electric tracing hand 12, output power of which may be adjusted automatically so as to prevent the pipe 11 from being overheated.

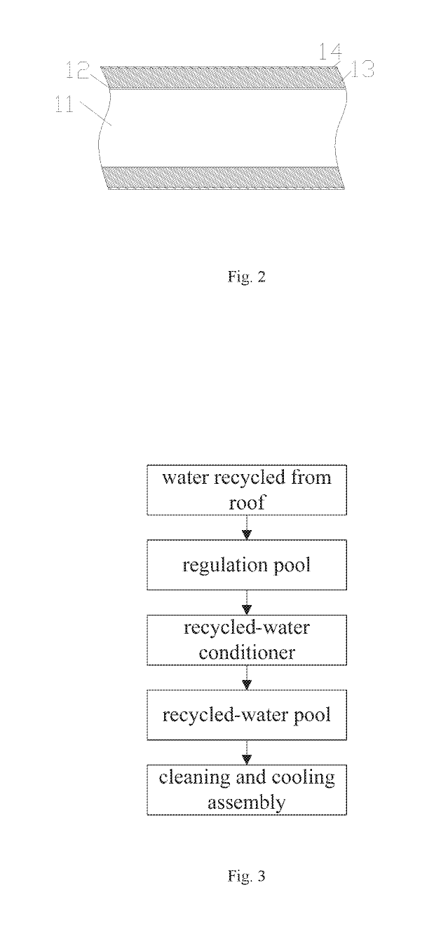

Further, as shown in FIG. 2, the pipe 11 includes a thermal insulation layer 13 and a fireproofing layer 14 sequentially enclosing the electric tracing band 12, so as to protect the pipe.

Optionally, the cleaning system further includes an ambient detector 7 configured to detect an ambient parameter at a place where the photovoltaic power station is located and send a signal when the ambient parameter meets a second predetermined condition. The controller 5 is further configured to control the sprinkler to clean the solar assembly 1 or stop cleaning the solar assembly 1 in accordance with the signal from the ambient detector 7.

The ambient parameter includes wind speed, wind direction or temperature. Whether or not the solar assembly 1 is to be cleaned by the cleaning system may be determined in accordance with the ambient parameter detected by the ambient detector 7, so as to improve the cleaning efficiency.

In this embodiment, the ambient detector 7 is an ambient tester.

Optionally, the cleaning system further includes a liquid level detector 6 configured to detect a water level of the water tank 105, and send a signal when the water level is less than a second predetermined value. The controller 5 is further configured to control the sprinkler to stop cleaning the solar assembly 1 in accordance with the signal from the liquid level detector 6.

Through the liquid level detector 6, it is able to stop cleaning the solar assembly 1 in time, thereby reducing the power consumption in case of too little water in the water tank.

In this embodiment, the liquid level detector 6 is a liquid level sensor.

Optionally, an alarm 118 may be arranged to remind a user to add water when the liquid level of the water tank 105 is less than the second predetermined value.

Optionally, in this embodiment, the cleaning system further includes a water recycling device configured to recycle the water for cleaning the solar assembly 1.

Referring to FIG. 3, the water recycled from the roof (i.e., the water that has been used to clean the solar assembly 1) is fed into a regulation pool 120 (for filtering impurities with a large particle size) and a recycled-water conditioner 122 (for filtering impurities with a small particle size), and then the processed water is fed into a recycled-water pool (i.e., the water tank 105) for cleaning the solar assembly 1. The procedure for processing the water is known in the art and thus will not be particularly defined herein.

Domestic sewage may also be collected and processed by the water recycling device, and then used for cleaning the solar assembly 1. Through the water recycling device, it is able to reuse the water, thereby reducing the water consumption. In addition, the recycled water may meet the requirements of cleaning and cooling the solar assembly.

Optionally, in this embodiment, the cleaning system further includes a temperature detector 9 arranged at a back surface of the solar assembly 1, and configured to detect a temperature of the solar assembly 1, and send a signal when the temperature of the solar assembly 1 exceeds a fourth predetermined value. The controller 5 is further configured to control the sprinkler to clean and cool the solar assembly 1 in accordance with the signal from the temperature detector 9.

In this embodiment, the temperature detector 9 includes a temperature sensor. When the temperature of the solar assembly 1 is too high, it is cleaned and cooled so as to improve its power generation efficiency.

For example, based on the signal from the optical fiber sensor 8, the photovoltaic power station may be cleaned three times a day, 15 minutes for each cleaning procedure. Of course, the cleaning duration and the cleaning times are not limited thereto, and they may be set in accordance with the practical need.

The dust content at the surface of the solar assembly 1 is related to the current ambient, and when the photovoltaic power station is cleaned too frequently, it will result in the waste of water and the power generation efficiency will be adversely affected somewhat. Hence, in this embodiment, the photovoltaic power station had better be cleaned at most three times a day based on the signal from the optical fiber sensor 8.

The temperature sensor s placed at a position of the back surface of the solar assembly 1 where the temperature is relatively high, so as to detect the temperature of the solar assembly 1. When the temperature of the solar assembly increases to the fourth predetermined value, based on the signal from the temperature sensor, the solar assembly 1 may be cooled six times a day, 10 minutes for each cooling procedure and at most twice every half an hour. Of course, the cooling duration and the cooling times are not limited thereto, and they may be set in accordance with the practical need.

The temperature of the solar assembly 1 is related to the ambient temperature, and the influence caused by a temporary high temperature on its power generation efficiency may be omitted. Hence, in this embodiment, the cooling times every day for the solar assembly 1 due to the high temperature may be limited, so as to reduce resource waste.

According to the cleaning system in the embodiments of the present disclosure, it is able to automatically clean the photovoltaic power station, thereby improving the cleaning efficiency as compared with a manual cleaning mode. In addition, through the dust detector, it is able to clean the photovoltaic power station in a more effective manner.

The above are merely the optional embodiments of the present disclosure. It should be appreciated that, a person skilled in the art may make further modifications and improvements without departing from the principle of the present disclosure, and these modifications and improvements shall also fall within the scope of the present disclosure.

What is claimed is:

1. A cleaning system for a photovoltaic power station, comprising:
a sprinkler;
a dust detector configured to determine a dust content at a surface of a solar assembly, and send a signal when the dust content at the surface of the solar assembly meets a first predetermined condition; and
a controller configured to control the sprinkler to clean the solar assembly in accordance with the signal from the dust detector.

2. The cleaning system according to claim 1, wherein the dust detector comprises:
a transparent detection plate arranged at a periphery of the solar assembly; and
a fiber optical sensor configured to emit a light beam perpendicular to the transparent detection plate and configured to sense light intensity of a received light beam reflected by dust on the transparent detection plate, determine the dust content at the surface of the solar assembly in accordance with the light intensity, and send a signal when the light intensity exceeds a first predetermined value;
wherein when the light intensity exceeds the first predetermined value, the dust content at the surface of the solar assembly meets the first predetermined condition.

3. The cleaning system according to claim 2, wherein the dust detector further comprises a light source configured to emit a light beam perpendicular to the transparent detection plate.

4. The cleaning system according to claim 1, wherein the sprinkler comprises:
a water tank,
a pump connected to the water tank;
a sprayer connected to the pump via a pipe; and
a solenoid valve arranged on the pipe and connected to the controller so as to control the flow of the sprayer.

5. The cleaning system according to claim 4, further comprising:
a liquid level detector configured to detect a water level of the water tank, and send a signal when the water level is less than a second predetermined value;
wherein the controller is further configured. to control the sprinkler to stop cleaning the solar assembly in accordance with the signal from the liquid level detector.

6. The cleaning system according to claim 4, wherein the sprinkler further comprises an adjustment mechanism configured to control an angle of the sprayer relative to a horizontal plane, thereby adjusting a spraying radius of the sprayer.

7. The cleaning system according to claim 4, further comprising a frequency converter configured to adjust the flow of the pump and soft-start the pump.

8. The cleaning system according to claim 4, further comprising a heater arranged on the pipe and configured to heat the pipe when a temperature of the pipe is less than a third predetermined value.

9. The cleaning system according to claim 8, wherein the heater is an electric tracing band.

10. The cleaning system according to claim 9, wherein the pipe comprises a thermal insulation layer and a fireproofing layer sequentially enclosing the electric tracing band.

11. The cleaning system according to claim 1, further comprising:
an ambient detector configured to detect an ambient parameter at a place where the photovoltaic power station is located and send a signal when the ambient parameter meets a second predetermined condition;
wherein the controller is further configured to control the sprinkler to clean the solar assembly or stop cleaning the solar assembly in accordance with the signal from the ambient detector.

12. The cleaning system according to claim 4, wherein the sprinkler further comprises an automatic drain valve arranged on the pipe.

13. The cleaning system according to claim 4, wherein the sprinkler further comprises a fastener for securing the pipe, and a cushion arranged between the fastener and the pipe.

14. The cleaning system according to claim 1, further comprising a water recycling device.

15. The cleaning system according to claim 1, further comprising:
a temperature detector arranged at a back surface of the solar assembly, and configured to detect a temperature of the solar assembly, and send a signal when the temperature of the solar assembly exceeds a fourth predetermined value;
wherein the controller is further configured to control the sprinkler to clean and cool the solar assembly in accordance with the signal from the temperature detector.
